(19) United States
(12) Patent Application Publication
(10) Pub. No.: US 2010/0241391 A1
(43) Pub. Date: Sep. 23, 2010

(54) APPARATUS AND METHOD FOR MEASURING THE VELOCITY AND ACCELERATION OF A VEHICLE USING SAD ALGORITHM

(75) Inventors: Christopher Pelczar, Daejeon-City (KR); Jung-Sook Kim, Seoul (KR); Byung-Tae Jang, Daejeon-city (KR); Jeong-Dan Choi, Daejeon-city (KR); Do-Hyun Kim, Daejeon-city (KR); Jae-Jun Yoo, Daejeon-city (KR); Kyung-Bok Sung, Daejeon-city (KR); Jeong-Ah Jang, Daejeon-city (KR); Jae-Han Lim, Daejeon-city (KR); Kyeong-Tae Kim, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Instit ute, Daeheon-city (KR)

(21) Appl. No.: 12/681,130

(22) PCT Filed: Jul. 30, 2008
(86) PCT No.: PCT/KR08/04428

§ 371 Date: Apr. 1, 2010

(30) Foreign Application Priority Data
Oct. 4, 2007 (KR) 10-2007-0099929
Dec. 18, 2007 (KR) 10-2007-0133743

(51) Int. Cl. G01P 15/00; G06F 15/00

(52) U.S. Cl. 702/141; 702/150

(57) ABSTRACT

Provided are a single-board type vehicle driving information measuring apparatus and method using a sum of absolute difference (SAD) hardware accelerator. In the vehicle driving information measuring apparatus and method, time differences between vehicle sensing signals sensed by two or more sensing units are accurately calculated in real time by the SAD hardware accelerator, and the velocity and acceleration of a vehicle can be accurately calculated based on the accurate time differences between the vehicle sensing signals. The vehicle driving information measuring apparatus is operated in two separate modes, that is, a vehicle sensing mode and a velocity measuring mode. Accordingly, power consumption of the apparatus can be minimized. In addition, the apparatus can be provided with a wireless transceiver, so that the apparatus can be constructed and operated without external cables. Further, functional blocks of the apparatus can be powered separately.

### TECHNICAL FIELD

The present invention relates to a vehicle driving information measuring apparatus and method using a sum-of-absolute-difference (SAD) algorithm, and more particularly, to a vehicle velocity and acceleration measuring apparatus and method using two or more sensing units disposed along a driving path of a vehicle.

The vehicle driving information measuring apparatus can be a single-board type measuring apparatus, and can calculate the velocity and acceleration of a vehicle by using a predetermined distance between the sensing units and a vehicle sensing time obtained based on signals sensed by the sensing units.

The present invention is derived from a research project supported by the Information Technology (IT) Research & Development (R&D) program of the Ministry of Information and Communication (MIC) and the Institute for Information Technology Advancement (IITA) [2006-S-024-02, Development of Telematics Application Service Technology based on USN Infrastructure].

### BACKGROUND ART

Conventional vehicle velocity measuring apparatuses and approaches are described below.

As a first conventional vehicle velocity measuring apparatus, 2-axis fluxgate magnetic sensors are used. Using this approach, a local change in a geomagnetic field caused by a vehicle is sensed by two 2-axis fluxgate magnetic sensors, and a velocity of the vehicle is calculated based on the change in the geomagnetic field.

More specifically, the velocity of the vehicle is calculated by using the changes in the geomagnetic field with respect to time and position.

In a case where a signal of the sensed geomagnetic field contains a lot of noise or in a case where the signal of the sensed geomagnetic field is complex, it is difficult to accurately calculate the velocity of the vehicle. In addition, the fluxgate magnetoresistive sensors consume a lot of power.

As a second conventional vehicle velocity measuring apparatus, magnetoresistive sensors are used.

In a vehicle velocity measuring apparatus using magnetoresistive sensors, a threshold-sensing algorithm for measurement of velocity is used.

However, the threshold sensing algorithm has a problem in that the sensors are separated from each other by a distance of several meters or more in order to accurately measure the velocity. Therefore, it is not easy to construct such a velocity measuring apparatus in an integrated fashion.

As a third conventional vehicle velocity measuring apparatus, two sensors are disposed along a driving path of an object (vehicle) to accurately measure a velocity of the object.

More specifically, a time difference is obtained based on cross-correlation between signals sensed by the consecutive sensors, and the velocity of the vehicle is calculated based on the obtained time difference. However, the third vehicle velocity measuring apparatus cannot be easily adapted to low-grade sensor nodes due to the requirement of a large amount of calculation.

### DISCLOSURE OF INVENTION

### Technical Solution

The present invention provides a single-board-type vehicle velocity and acceleration measuring apparatus using a sum-of-absolute-difference (SAD) hardware accelerator having a relatively simple algorithm, and which is capable of accurately measuring the velocity and acceleration of a vehicle in real time.

### Advantageous Effects

The present invention also provides a vehicle velocity and acceleration measuring apparatus that uses a SAD algorithm, and which is capable of supporting a low-power function and a wireless communication function.

### DESCRIPTION OF DRAWINGS

The above and other features and advantages of the present invention will become more apparent by describing in detail exemplary embodiments thereof with reference to the attached drawings in which:

FIG. 1 is a road layout of a vehicle driving information measuring apparatus for measuring the velocity and acceleration of a vehicle, according to an embodiment of the present invention;

FIG. 2 is a graph illustrating real signals sensed from a vehicle driving at 30 km/h on a road in which sensing units of the vehicle driving information measuring apparatus of FIG. 1 are disposed at intervals of 11 cm;

FIG. 3 is a block diagram illustrating a configuration of a vehicle driving information measuring apparatus based on a sum-of-absolute-difference (SAD) algorithm using partial vehicle sensing signals, according to an embodiment of the present invention;

FIG. 4 is a flowchart illustrating a method of measuring the velocity of a vehicle based on a SAD algorithm using partial vehicle sensing signals in a vehicle driving information measuring apparatus according to the present invention, according to an embodiment of the present invention; and

FIGS. 5A and 5B are views illustrating a configuration of a SAD hardware accelerator of a vehicle driving information measuring apparatus according to the present invention, according to an embodiment of the present invention.

### BEST MODE

According to an aspect of the present invention, there is provided a vehicle driving information measuring apparatus comprising: a first sensing unit which senses a driving vehicle; a second sensing unit which senses the driving vehicle at a position separated by a predetermined distance difference from the first sensing unit; an SAD (sum of absolute difference) accelerator which obtains a time difference corresponding to a highest degree of similarity between vehicle driving signals sensed by the first and second sensing units by using an SAD algorithm; and a central processing unit which calculates a velocity of the vehicle based on the distance difference between the first and second sensing units and the time difference obtained by the SAD hardware accelerator.

According to another aspect of the present invention, there is provided a method of measuring vehicle driving information, comprising: a first sensing unit sensing a driving vehicle; a second sensing unit sensing the driving vehicle at a position separated by a predetermined distance from the first sensing unit; obtaining a time difference corresponding to a highest degree of similarity between vehicle driving signals sensed by the first and second sensor units by using an SAD algorithm; and calculating a velocity of the vehicle based on the distance between the first and second sensing units and the time difference corresponding to the highest degree of similarity.

### MODE FOR INVENTION

Hereinafter, the present invention will be described in detail by explaining exemplary embodiments of the invention with reference to the accompanying drawings.

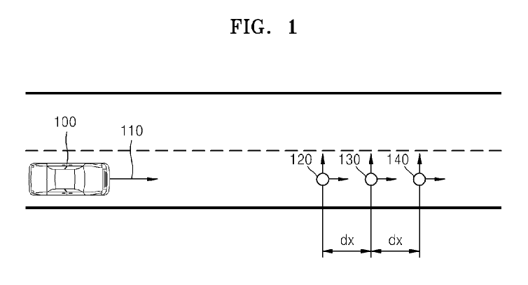

FIG. 1 is a road layout of a vehicle driving information measuring apparatus for measuring the velocity and acceleration of a vehicle, according to an embodiment of the present invention.

The vehicle driving information measuring apparatus according to the current embodiment of the present invention is constructed on a single board. The vehicle driving information measuring apparatus includes sensing units 120, 130, and 140, which are consecutively disposed in a direction 110 parallel to a driving path of a vehicle 100.

The sensing units 120, 130, and 140 are single-axis or multi-axis magnetoresistive sensors.

The vehicle driving information measuring apparatus is constructed along a central portion or a side portion of the driving path of the vehicle 100. The sensing units 120, 130, and 140 are disposed at intervals dx along the driving path of the vehicle 100.

The sensing units 120, 130, and 140 are disposed so that, as the vehicle is driven parallel to and past the sensing units 120, 130, and 140, similar signal patterns repeatedly occur with a predetermined time difference in the vehicle sensing signals sensed by the sensing units 120, 130, and 140.

That is, two vehicle sensing signals sensed by two sensing units have similar signal patterns with a time interval dt taken to drive the vehicle the distance dx between the two sensing units.

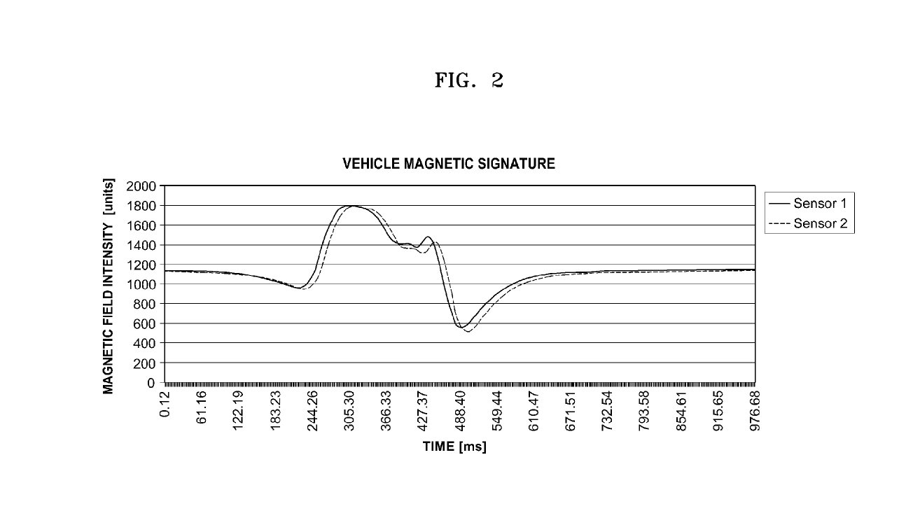

FIG. 2 is a graph illustrating real signals sensed from a vehicle being driven at 30 km/h on a road in which sensing units 120, 130, and 140 of the vehicle driving information measuring apparatus of FIG. 1 are disposed at intervals of 11 cm.

Referring to the graph of FIG. 2, it can be seen that a pattern of the vehicle sensing signal sensed by a second sensing unit (130 of FIG. 1) is similar to that of the vehicle sensing signal sensed by a first sensing unit (120 of FIG. 1) with the time difference dx.

When the vehicle passes a sensing region of a sensing unit, the sensing unit senses a vehicle sensing signal.

The vehicle sensing signal has different patterns according to the type of the vehicle. The entire vehicle sensing signal or a partial vehicle sensing signal may be used to measure the velocity of the vehicle.

The vehicle driving information measuring apparatus according to the current embodiment of the present invention can calculate the velocity and acceleration of the vehicle by using the distance dx between the sensing units (which is defined at the time of designing the apparatus) and the time difference dt obtained from the vehicle sensing signals sensed by the sensing units.

The accuracy of the calculated velocity and acceleration of the vehicle is proportional to the accuracy of the time difference dt between the vehicle sensing signals.

Due to noise and characteristics of the sensing units, the vehicle sensing signal of each sensing unit may have a variation. Such a variation of the vehicle sensing signal causes deterioration in the accuracy of measurement of the velocity and acceleration of the vehicle.

Therefore, there is a need for an algorithm for providing a high degree of accuracy of the measurement of the velocity and acceleration of the vehicle irrespective of the variation of the vehicle sensing signals.

In order to obtain the time difference dt between the vehicle sensing signals sensed by the consecutive sensing units for the measurement of the velocity of the vehicle, a metric of the signal similarity between the vehicle sensing signals is obtained, and a time difference corresponding to the highest similarity between the vehicle sensing signals is used as the time difference dt.

In order to obtain the time difference corresponding to the highest similarity between the vehicle sensing signals, an algorithm for measuring signal similarities such as a cross-correlation algorithm, a sum-of-absolute-difference (SAD) algorithm, or a sum-of-square-difference (SSD) algorithm may be used.

The algorithm for measuring signal similarities involves a large amount of calculation. In particular, the amount of calculation is proportional to lengths of the signals that are to be compared with each other.

Accordingly, if an algorithm for measuring signal similarities is simple, the amount of calculation can be reduced, and the velocity of the vehicle can be measured in real time.

Among various algorithms, the SAD algorithm, which has no product calculation, is simple and can be implemented in a hardware manner. Thus, the SAD algorithm is suitable for the real-time measurement of the velocity of the vehicle.

In the SAD algorithm, a sum of absolute values of differences between two signals is calculated.

If the two signals are completely equal to each other, the SAD value is zero.

A time difference corresponding to the highest similarity between the signals sensed by the two vehicle sensing units is a time difference corresponding to a minimum SAD value.

Equation 1 below expresses an example of a method of measuring the velocity of a vehicle using the SAD algorithm.

$$\begin{matrix}[ Equation 1 ] & \\ Δ t = arg {min}_{d} {\{ {\sum }_{t = 0}^{{t}_{max} - {d}_{max}} \vert \begin{matrix}( {s}_{1} ( t ) - {b}_{1} ) - \\ ( {s}_{2} ( t + d ) - {b}_{2} )\end{matrix} \vert \}}_{d = 1}^{{d}_{max}} & [ Math . 1 ]\end{matrix}$$

Here, S₁(t) and S₂(t) denotes signal values sensed at a time t by consecutive first and second sensing units of the vehicle driving information measuring apparatus according to the current embodiment, respectively.

tₘₐₓ denotes a length of a sensed signal, and dₘₐₓ denotes a maximum time difference between two vehicle sensing signals which can be obtained by using the SAD algorithm.

b₁ and b₂ denote basis values of the first and second sensing units, respectively.

A minimum velocity which can be measured by the vehicle driving information measuring apparatus according to the current embodiment is determined based on the maximum time difference dₘₐₓ.

The basis value in Equation 1 is a signal value sensed when there is no vehicle or object sensed by the sensing apparatus in the sensing region of the sensing apparatus. The basis value is treated as a DC offset value

Since the basis value may be varied, the variation of the basis value needs to be compensated periodically.

In order to measure the velocity and acceleration of the vehicle in real time, the SAD algorithm of the vehicle driving information measuring apparatus detects the time difference between the vehicle sensing signals sensed by the sensing units by using only the partial vehicle sensing signals instead of the entire vehicle sensing signals, that is, the vehicle sensing signals sensed from the time when the vehicle enters the sensing region to the time when the vehicle leaves the sensing region.

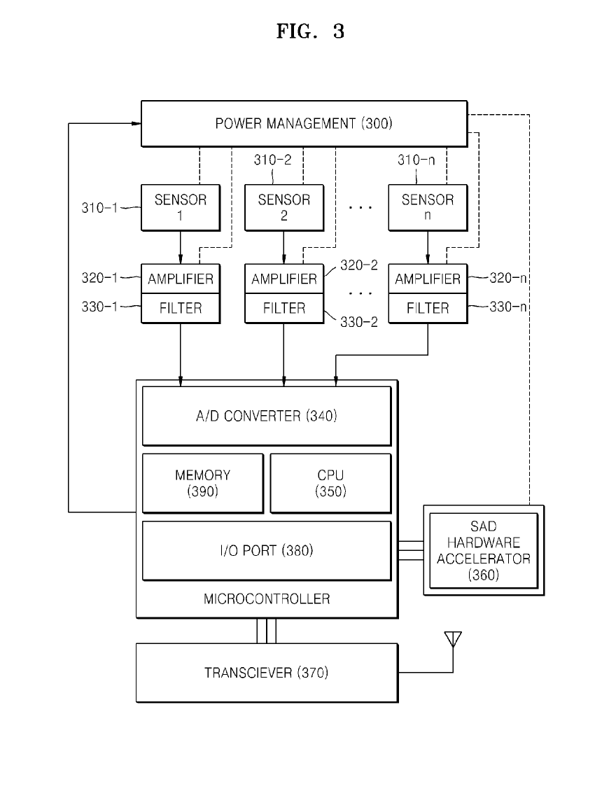

FIG. 3 is a block diagram illustrating a configuration of a vehicle driving information measuring apparatus based on a SAD algorithm using partial vehicle sensing signals, according to an embodiment of the present invention.

Referring to FIG. 3, the vehicle driving information measuring apparatus according to the current embodiment of the present invention includes two or more sensing units 310-1, 310-2, . . . , and 310-n which sense the vehicle, amplifiers 320-1, 320-2, . . . , and 320-n which amplify the sensed signals, low pass filters 330-1, 330-2, . . . , and 330-n which remove noise from the amplified signals, an A/D converter 340 which converts the sensed analog vehicle sensing signals to digital signals, a central processing unit (CPU) 350 which calculates the velocity and acceleration of the vehicle, a SAD hardware accelerator 360 which obtains an optimal time difference between the sensed signals, and a transceiver 370 through which the vehicle driving information measuring apparatus and a road-side apparatus can wirelessly communicate various types of data including the calculated velocity and acceleration of the vehicle.

At least two of the sensing units 310-1, 310-2, . . . , and 310-n are needed for measuring the velocity, and at least three of the sensing units 310-1, 310-2, . . . , and 310-n are needed for measuring the acceleration.

The sensing units 310-1, 310-2, . . . , and 310-n may be disposed at intervals in a range of centimeters to tens of centimeters according to the to-be-measured velocity and its accuracy.

The signal sensed by each sensing unit is amplified by the corresponding one of the amplifiers 320-1, 320-2, . . . 320-n, and after that, noise is removed therefrom by the corresponding one of the low pass filters 330-1, 330-2, . . . , and 330-n.

The CPU 350 samples the output signals of the low pass filters 330-1, 330-2, . . . , and 330-n by using the A/D converter 340 and transfers the sampled signals as input signals to the SAD hardware accelerator 360.

The SAD hardware accelerator 360 analyzes degrees of similarity between the input signals to obtain the optimal time difference and transfers the optimal time difference to the CPU 350.

The CPU 350 calculates the velocity of the vehicle based on the optimal time difference and the distance between the sensing units 310-1, 310-2, . . . , and 310-n.

Equation 2 below is an equation for measuring the velocity of the vehicle, used in the vehicle driving information measuring apparatus according to the current embodiment of the present invention.

v=(dx*fₓ)/Δt [Equation 2]

Here, dx denotes the distance between two sensing units; fₓ denotes a sampling frequency; and Δt denotes the number of sampling intervals obtained by using the SAD algorithm.

An effective quantum number of the time difference is determined by the sampling frequency in Equation 2.

If there is a lot of noise in two signals sensed by the sensing units or if the two signals do not have similar patterns, an error in Δt may be increased. In this case, by increasing dx, the accuracy of measurement of the velocity can be increased.

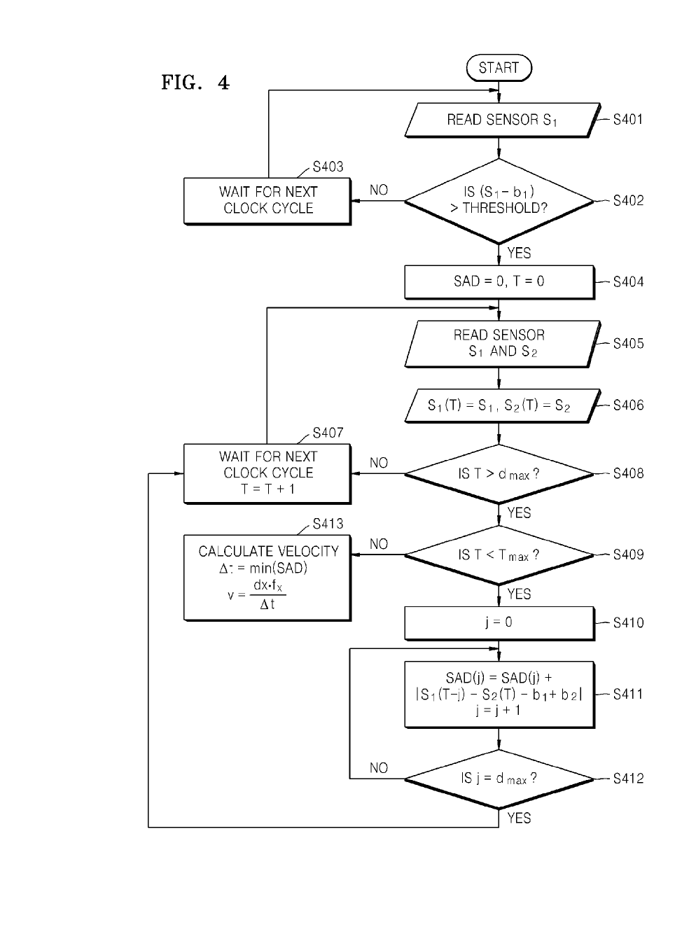

FIG. 4 is a flowchart illustrating a method of measuring a velocity of a vehicle based on a SAD algorithm using partial vehicle sensing signals in a vehicle driving information measuring apparatus according to the present invention, according to an embodiment of the present invention.

First, a first sensing unit of the vehicle driving information measuring apparatus is periodically activated to sense the vehicle and stores a sensed signal value S₁ (S401).

Then a difference (S₁−b₁) between the sensed signal S₁ and a basis value b₁ of the first sensing unit is calculated (S402). If the calculated difference (S₁−b₁) is less than a threshold value, the first sensing unit determines that the vehicle is not sensed and attempts to sense the vehicle again (S403).

If the difference (S₁−b₁) between the sensed signal S₁ and the basis value b₁ is greater than the threshold value, the first sensing unit determines that the vehicle is sensed and sets the SAD value and a T value to 0 and 0, respectively (S404).

The first sensing unit and a second sensing unit sense the vehicle (S405) and store sensed values S₁(T) and S₂(T) (S406).

The first and second sensing units set T=T+1 at the next sampling period to sense the vehicle (S407) and store the sensed values S₁(T) and S₂(T). These operations are repeatedly performed until T is greater than dₘₐₓ (S408).

If T is greater than dₘₐₓ and if T is less than Tₘₐₓ (S409), an index j is set to 0 (S410).

A value SAD(j) is calculated by using the aforementioned operations, and after that, the index j is increased by 1 (S411). The aforementioned operations are repeatedly performed until j=dₘₐₓ (S412). If j=dₘₐₓ, the method proceeds to operation 407.

As a result of operation 409, if T is equal to or greater than Tₘₐₓ, the optimal time difference Δt between the two vehicle sensing signals is selected as the index j of the minimum value among the SAD values calculated in operation S411, and after that, the velocity of the vehicle is calculated based on the optimal time difference Δt (S413).

The above-described operations can be expressed by pseudo code as follows.

| | |
|---|---|
| 1. | SAD[j] = 0; |
| 2. | for (k = 0; k < dmax; k++) |
| 3. | { |
| 4. | s1[k] = SampleField1( ); // get first magnetic sensor reading |
| 5. | s2[k] = SampleField2( ); // get second mangetic sensor reading |
| 6. | } |
| 7. | for (k = dmax; k <= tmax−dmax; k++) |
| 8. | { |
| 9. | s1[k] = SampleField1( ); // get first magnetic sensor reading |
| 10. | s2[k] = SampleField2( ); // get second magnetic sensor reading |
| 11. | for (j = 0; j <= dmax; j++) |
| 12. | { |
| 13. | AbsDiff = abs(s1[k−j]−s2[k]−b1+b2); // calculate absolute difference |
| | of signals for different time shifts |
| 14. | SAD[j] += AbsDiff; // update SAD absolute difference |
| 15. | } |
| 16. | } |
| 17. | Timeshift = min(SAD); // find the value of j for which SAE(j) takes |
| | the minimum value |

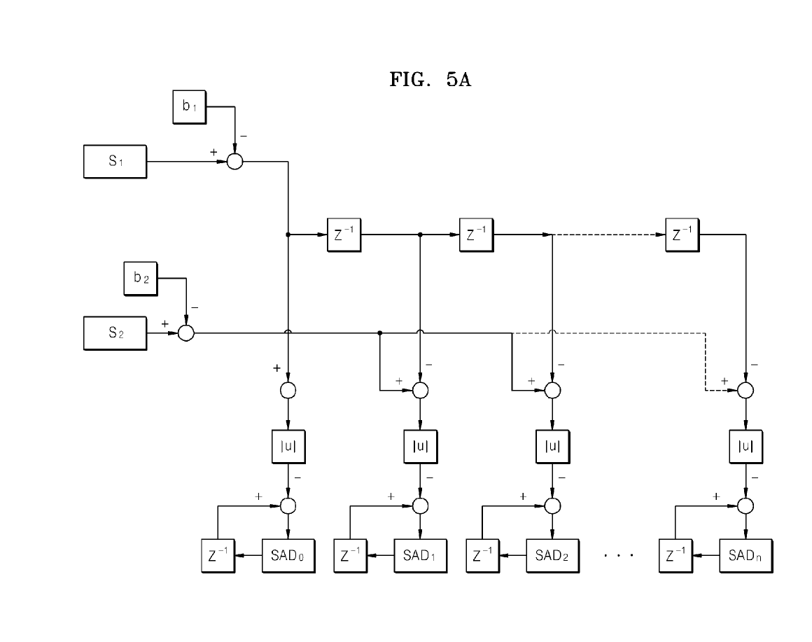

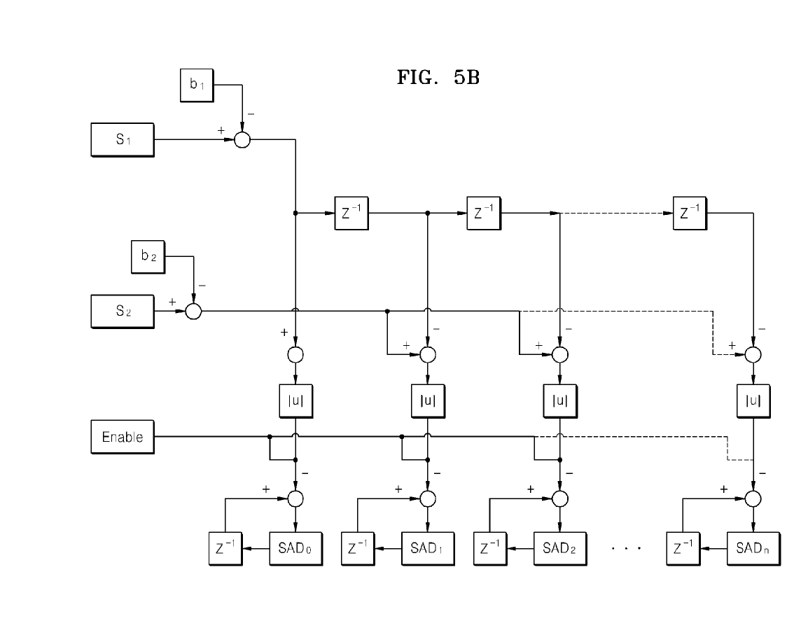

FIGS. 5A and 5B are views illustrating a configuration of a SAD hardware accelerator of a vehicle driving information measuring apparatus according to the present invention, according to an embodiment of the present invention.

The SAD hardware accelerator according to the current embodiment performs the operations described in lines 7 to 14 in the above pseudo code of the SAD algorithm for a short time.

According to another embodiment of the present invention, a vehicle velocity measuring apparatus having three or more sensing units can also measure the acceleration of a vehicle.

Firstly, the vehicle velocity measuring apparatus having three or more sensing units measures two velocity values based on signals sensed by two consecutive sensing units.

That is, a velocity V₁ of the vehicle is measured based on the sensed signals sensed by first and second sensing units, and after that, a velocity V₂ of the vehicle is measured based on the sensed signals sensed by the second and third sensing units.

The acceleration of the vehicle can be calculated based on the velocities V₁ and V₂ of the vehicle by using Equation 3 below.

a=(V₂−V₁)/dt₂ [Equation 3]

Here, dt₂ denotes a time difference between the sensing signals sensed by the second and third sensing units.

When the sensing signal sensed by one of the sensing units of the vehicle velocity measuring apparatus is greater than the basis value, the vehicle velocity measuring apparatus determines that a vehicle is approaching the vehicle velocity measuring apparatus and enters into a mode of measuring the velocity and acceleration to perform the operations of obtaining the time difference based on the signals sensed by the sensing units.

In order to minimize power consumption of the vehicle velocity measuring apparatus, the vehicle velocity measuring apparatus is designed to include various functional blocks and controls power supplied to the functional blocks separately.

For lower power operations, the vehicle velocity measuring apparatus supports a low-power vehicle sensing mode and a vehicle velocity measuring mode.

In the vehicle sensing mode, the vehicle velocity measuring apparatus activates one of the sensing units periodically to sense the vehicle at a low sampling frequency.

If a value of the sensing signal is greater than a threshold value, the vehicle velocity measuring apparatus determines that the vehicle has entered the sensing region and switches the vehicle sensing mode to the vehicle velocity measuring mode.

In the vehicle sensing mode, the sensing units of the vehicle velocity measuring apparatus sense the vehicle at a high sampling frequency to generate signals.

The sensed signals are used to obtain the time difference between the signals by using the SAD algorithm.

The vehicle velocity measuring apparatus transmits the measured velocity of the vehicle via the wireless transceiver to a receiver disposed at a side portion of the road.

The cost of construction of the vehicle velocity measuring apparatus can be reduced by using such a wireless communication scheme.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, there is provided a single-board type vehicle velocity and acceleration measuring apparatus using a SAD hardware accelerator having a relatively simple algorithm, which is capable of accurately measuring the velocity and acceleration of a vehicle in real time.

In addition, since a low-power function is provided, an internal power supply of the vehicle velocity and acceleration measuring apparatus can be supported. Further, since wireless communication is used, external cables for operations of the apparatus are un-necessary.

Accordingly, the cost of construction of the apparatus on a road is cheaper than that of an existing loop sensor for sensing the velocity of the vehicle.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A vehicle driving information measuring apparatus comprising:
a first sensing unit which senses a driving vehicle;
a second sensing unit which senses the driving vehicle at a position separated by a predetermined distance from the first sensing unit;
a sum of absolute difference (SAD) hardware accelerator which obtains a time difference corresponding to a highest degree of similarity between vehicle driving signals sensed by the first and second sensing units by using a SAD algorithm; and
a central processing unit which calculates a velocity of the vehicle based on the distance between the first and second sensing units and the time difference obtained by the SAD hardware accelerator.

2. The vehicle driving information measuring apparatus of claim 1, wherein the first sensing unit, the second sensing unit, the SAD hardware accelerator, and the central processing unit are constructed on a single board and buried along a central portion or a side portion of a road for the driving vehicle.

3. The vehicle driving information measuring apparatus of claim 1, further comprising a third sensing unit which senses the driving vehicle at a position separated by a predetermined distance from the second sensing unit,
wherein the SAD hardware accelerator obtains a time difference corresponding to a highest degree of similarity between vehicle driving signals sensed by the second and third sensing units, and
wherein the central processing unit calculates the velocity of the vehicle and an acceleration of the vehicle based on the distance between the first and second sensing unit, the distance between the second and third sensing units, and the time difference obtained by the SAD hardware accelerator.

4. The vehicle driving information measuring apparatus of claim 1, further comprising:
an amplifier which amplifies the vehicle driving signals sensed by the first and second sensing units;
a low pass filter which removes noise from the amplified signals; and
an A/D converter which converts the amplified vehicle driving signals from which noise has been removed into digital signals.

5. The vehicle driving information measuring apparatus of claim 1, wherein the first and second sensing units are single-axis or multi-axis magnetoresistive sensors.

6. The vehicle driving information measuring apparatus of claim 1, further comprising a wireless transceiver which wirelessly transmits the velocity calculated by the central processing unit or wirelessly receives the vehicle driving signals.

7. The vehicle driving information measuring apparatus of claim 1, wherein the first sensing unit, the second sensing unit, the SAD hardware accelerator, and the central processing unit are powered separately.

8. A method of measuring vehicle driving information, comprising:
a first sensing unit sensing a driving vehicle;
a second sensing unit sensing the driving vehicle at a position separated by a pre-determined distance from the first sensing unit;
obtaining a time difference corresponding to a highest degree of similarity between vehicle driving signals sensed by the first and second sensor units by using a SAD algorithm; and
calculating a velocity of the vehicle based on the distance between the first and second sensing units and the time difference corresponding to the highest degree of similarity.

9. The method of claim 8, further comprising a third sensing unit sensing the driving vehicle at a position separated by a predetermined distance from the second sensing unit,
wherein, in the obtaining of the time difference corresponding to the highest degree of similarity, a time difference corresponding to a highest degree of similarity between the vehicle driving signals sensed by the second and third sensing units is obtained, and
wherein the method further comprises calculating the velocity of the vehicle and an acceleration of the vehicle based on the distance between the first and second sensing units, the distance between the second and third sensing units and the time difference corresponding to the highest degree of similarity.

10. The method of claim 8, further comprising:
amplifying the vehicle driving signals sensed by the first and second sensing units;
removing noise from the amplified signals; and
converting the amplified vehicle driving signals from which noise has been removed into digital signals.
